(19) United States
(12) Patent Application Publication
(10) Pub. No.: US 2022/0271852 A1
(43) Pub. Date: Aug. 25, 2022

(54) MULTIPLE ANTENNA CHANNEL TRACKING UNDER PRACTICAL IMPAIRMENT

(71) Applicant: Samsung Electronics Co., Ltd., Suwon-si (KR)

(72) Inventors: Yeqing Hu, Allen, TX (US); Yang Li, Plano, TX (US); Rui Wang, San Jose, CA (US); Junmo Sung, Richardson, TX (US); Tiexing Wang, Plano, TX (US); Jianzhong Zhang, Plano, TX (US)

(21) Appl. No.: 17/481,048

(22) Filed: Sep. 21, 2021

Related U.S. Application Data
(60) Provisional application No. 63/152,133, filed on Feb. 22, 2021.

(51) Int. Cl. H04B 17/391

(52) U.S. Cl. CPC H04B 17/3913; H04W 88/08

(57) ABSTRACT

Methods and apparatuses for a BS in a communication system. The method comprises: identifying antenna groups; identifying channel coefficients for each of the antenna groups to perform a channel tracking and prediction operation; receiving, from a user equipment (UE), an uplink signal to perform the channel tracking and prediction operation; and performing, based at least in part on the received uplink signal, a channel coefficient tracking operation for the channel coefficients of the antenna groups, respectively, the channel coefficient tracking operation including a channel subspace parameter tracking operation and a subspace coefficient tracking operation.

### CROSS-REFERENCE TO RELATED APPLICATIONS AND CLAIM OF PRIORITY

The present application claims priority to U.S. Provisional Patent Application No. 63/152,133, filed on Feb. 22, 2021. The content of the above-identified patent document is incorporated herein by reference.

### TECHNICAL FIELD

The present disclosure relates generally to wireless communication systems and, more specifically, the present disclosure relates to a multiple antenna channel tracking operation under practical impairment condition.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a multiple antenna channel tracking operation under practical impairment condition.

In one embodiment, a base station (BS) is provided. The BS comprises a processor configured to: identify antenna groups and identify channel coefficients for each of the antenna groups to perform a channel tracking and prediction operation. The BS further comprises a transceiver operably connected to the processor, the transceiver configured to receive, from a user equipment (UE), an uplink signal to perform the channel tracking and prediction operation, wherein the processor is further configured to perform, based at least in part on the received uplink signal, a channel coefficient tracking operation for the channel coefficients of the antenna groups, respectively, the channel coefficient tracking operation including a channel subspace parameter tracking operation and a subspace coefficient tracking operation.

In another embodiment, a method of a BS is provided. The method comprises: identifying antenna groups; identifying channel coefficients for each of the antenna groups to perform a channel tracking and prediction operation; receiving, from a user equipment (UE), an uplink signal to perform the channel tracking and prediction operation; and performing, based at least in part on the received uplink signal, a channel coefficient tracking operation for the channel coefficients of the antenna groups, respectively, the channel coefficient tracking operation including a channel subspace parameter tracking operation and a subspace coefficient tracking operation.

In yet another embodiment, a non-transitory computer-readable medium is provided. The non-transitory computer-readable medium comprising program code, that when executed by a processor, causes a base station (BS) to: identify antenna groups; identify channel coefficients for each of the antenna groups to perform a channel tracking and prediction operation; receive, from a user equipment (UE), an uplink signal to perform the channel tracking and prediction operation; and perform, based at least in part on the received uplink signal, a channel coefficient tracking operation for the channel coefficients of the antenna groups, respectively, the channel coefficient tracking operation including a channel subspace parameter tracking operation and a sub space coefficient tracking operation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIGS. 4 and 5 illustrate example wireless transmit and receive paths according to this disclosure;

FIG. 6 illustrates an example antenna structure according to embodiments of the present disclosure;

FIG. 7 illustrates a flowchart of a method for a channel prediction operation according to embodiments of the present disclosure;

FIG. 8A illustrates an example tracking and prediction operation according to embodiments of the present disclosure;

FIG. 8B illustrates an example antenna array for tracking and prediction operation according to embodiments of the present disclosure;

FIG. 9 illustrates an example ToFo impact removal operation before entire processing according to embodiments of the present disclosure;

FIG. 10 illustrates an example ToFo impact removal operation after the subspace tracking operation according to embodiments of the present disclosure;

FIG. 11 illustrates an example antenna differentiation operation followed by channel tracking operation according to embodiments of the present disclosure; and

FIG. 12 illustrates a flowchart of a method for a multiple antenna channel tracking procedure according to embodiments of the present disclosure.

### DETAILED DESCRIPTION

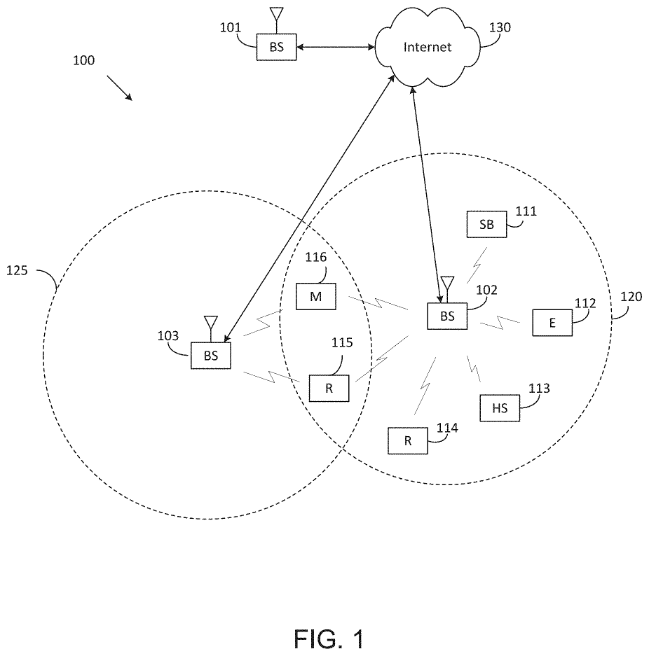

FIGS. 1 through FIG. 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a multiple antenna channel tracking operation. In certain embodiments, and one or more of the gNBs 101-103 includes circuitry, programing, or a combination thereof, for a multiple antenna channel tracking operation.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

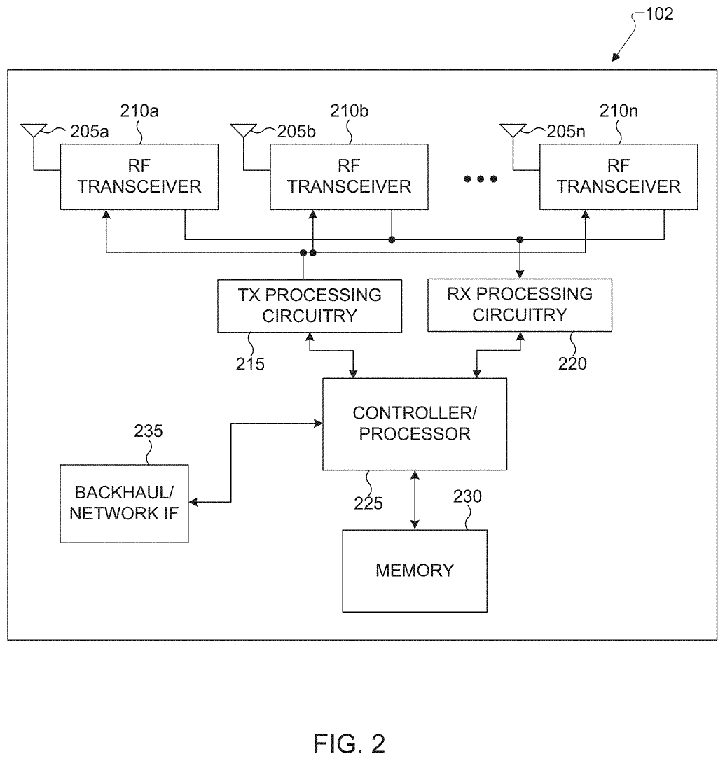

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

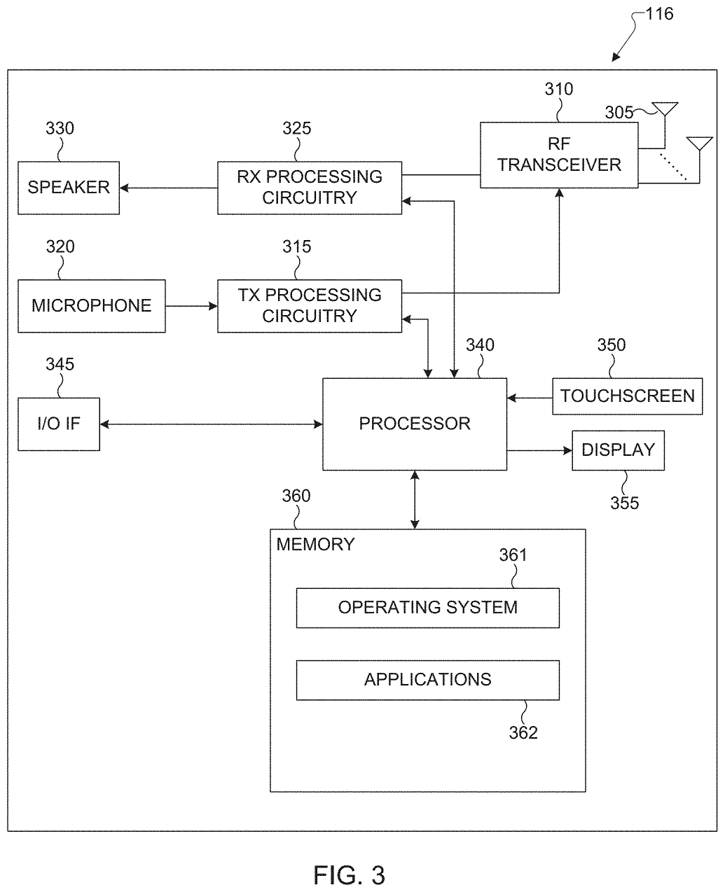

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for a multiple antenna channel tracking operation. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 30 KHz or 15 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DM-RS is transmitted only in the BW of a respective PDCCH or PDSCH and a UE can use the DMRS to demodulate data or control information.

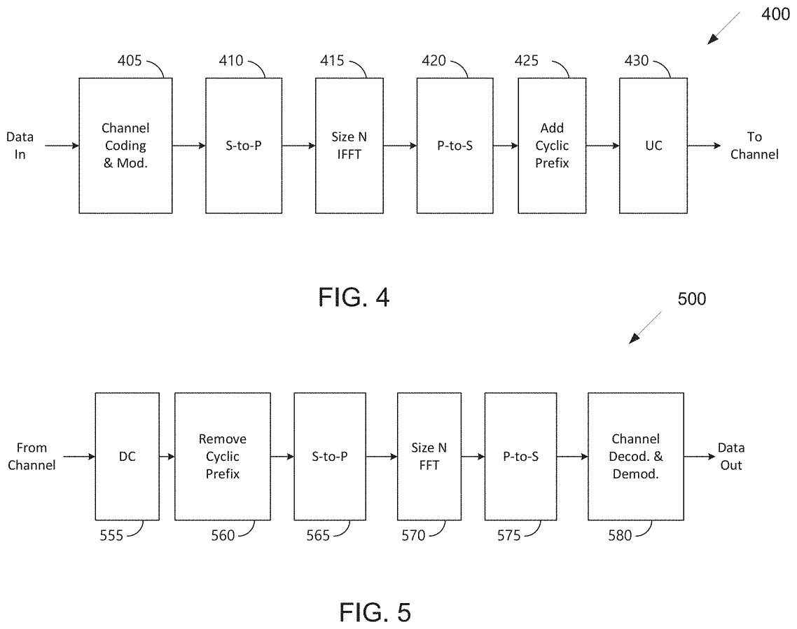

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the beam indication channel in a multi-beam system as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNB s 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

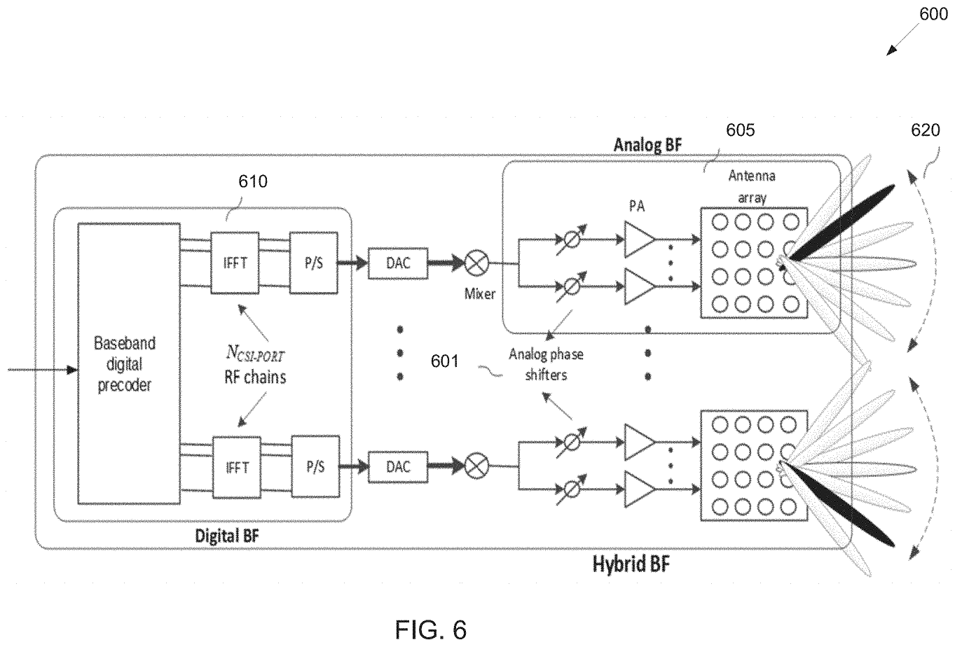

FIG. 6 illustrates an example antenna structure 600 according to embodiments of the present disclosure. An embodiment of the antenna structure 600 shown in FIG. 6 is for illustration only.

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated by beamforming architecture 600 in FIG. 6. In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks.

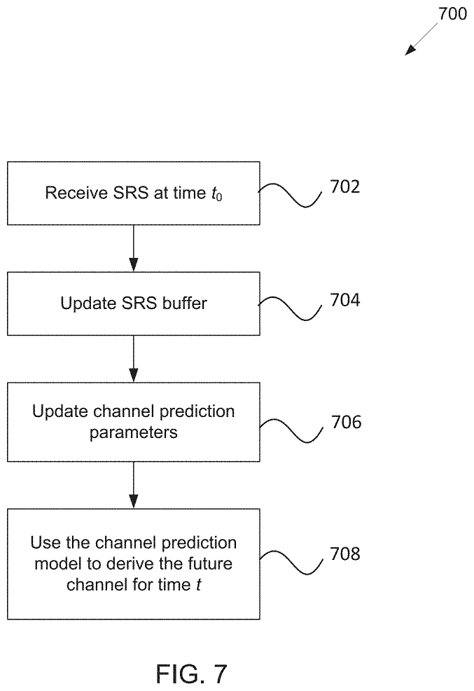

FIG. 7 illustrates a flowchart of a method 700 for a channel prediction operation according to embodiments of the present disclosure. For example, the method 700 may be implemented by a base station such as 101-103 as illustrated in FIG. 1. An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7, uplink timing and frequency offsets are unavoidable effect that are caused by UEs. A random timing offset in the present disclosure refers to the sample-wise UL timing adjustment performed by a UE at random time instances depending on UE's own assessment of the time drift to eNB/gNB.

Each UE tries to correct a carrier frequency offset (CFO) based on downlink signals from eNB and leaves an unpredictable amount of a residual CFO. The impact of the random residual CFO is to induce a random phase rotation on SRS observed by eNB/gNB, and such phase rotation is common to all eNB/gNB antennas and all frequency samples in the same SRS symbol.

In a channel prediction problem, a subspace based method can be applied. This type of method tracks the dominant (subspace) directions and time varying coefficients of channel matrix. The (subspace) direction is relatively slow-varying in the time domain, while the coefficients of each (subspace) direction is fast varying.

When the directions and the coefficients are tracked well, it is possible to predict the future channel coefficients, hence alleviate the channel aging effect.

However, the random CFO and timing offset introduces unpredictable features for the coefficients in the time domain. The impact of CFO may be removed to perform meaningful tracking and prediction. The removal of CFO impact can be applied to either the subspace tracking/prediction stage or the coefficient tracking/prediction stage.

As illustrated in FIG. 7, at step 702, a base station such as 101-103 as illustrated in FIG. 1 receives SRS at time to. At step 704, the base station updates an SRS buffer. Subsequently, at step 706, the base station updates channel prediction parameters. Finally, the base station at step 708 uses the channel prediction model to derive the future channel for time t.

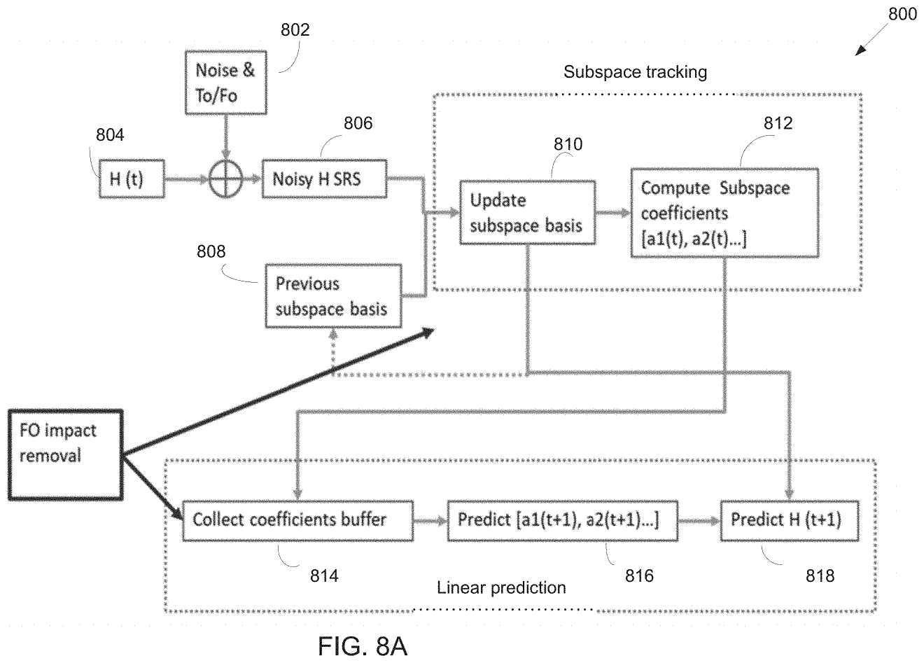

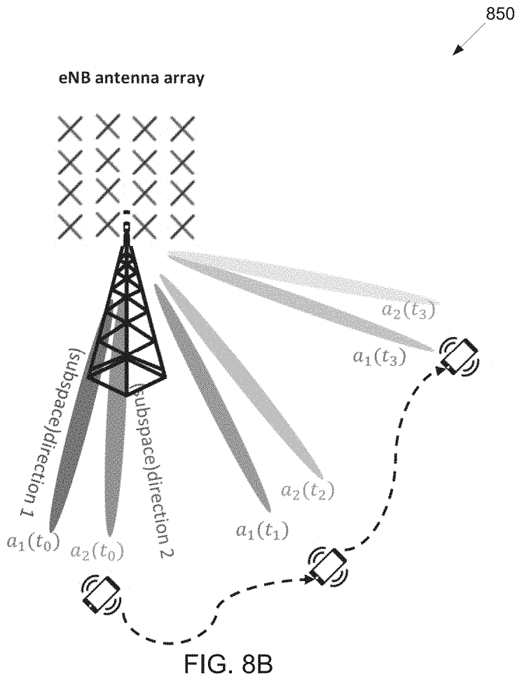

FIG. 8A illustrates an example tracking and prediction operation 800 according to embodiments of the present disclosure. For example, the tracking and prediction operation 800 may be implemented by a base station such as 101-103 as illustrated in FIG. 1. An embodiment of the tracking and prediction operation 800 shown in FIG. 8A is for illustration only. One or more of the components illustrated in FIG. 8A can be implemented in specialized circuitry configured to perform the noted functions or one or more of the components can be implemented by one or more processors executing instructions to perform the noted functions.

Denote the channel matrix of a certain RB m, at time instance t, as H_{m,t}, of dimension N_{R}×N_{T} composed of channel coefficients from N_{T} transmission antennas, and N_{R} reception antennas. Denote the srs transmitted from an arbitrary transmission antenna as h_{m,t,n}, an N_{R}×1 vector. Below examples focus on channels from one transmission antenna.

Assuming the channel is composed of P dominant subspace directions, it can be approximated as: h_{m,t,n}≈h̅_{m,t,n}=Σ_{p=1 . . . P} α_{p,m,t}w_{p,m,t}.

Using a sub-space tracking method, based on past observations from h_{m,t-T,n}, h_{m,t-(2T),n} . . . h_{m,t-kT,n}, the corresponding α_{p,m,t-T} , α_{p,m,t-2T}, . . . α_{p,m,t-kT} and w_{p,m,t-T}, w_{p,m,t-2T}, . . . w_{p,m,t-kT} can be estimated.

Assuming the dominant directions w_{p,m,t} change slowly over time, such that ŵ_{p,m,t+Δt}≈w_{p,m,t}. The coefficient α_{p,m,t} is relatively fast varying, and one can apply filter \hat{α}_{p,m,t+Δt}=Σβ(−x)α_{p,m,t-x} to predict future coefficients.

The predicted channel at time t+Δt is constructed as: ĥ_{m,t+Δt,n}=Σ_{p=1 . . . P}\hat{α}_{p,m,t+Δt}ŵ_{p,m,t+Δt}.

The computation of requires computation of auto-correlation function (ACF) of α, i.e., c(−x)=Eᵢ[α_{p,m,i}·α*_{p,m,i-x}].

However, due to the timing offset (TO) and frequency offset (FO) introduced by the UE clock, a random phase is introduced at every α estimate, i.e., \tilde{α}_{p,m,t}=α_{p,m,t}·e^{jϕ}^{ₜ}, and the computed ACF is distorted as: \tilde{c}(−x)=Eᵢ[α_{p,m,i}e^{jϕ}^{ₜ}·α*_{p,m,i-x}e^{-jϕ}^{_{t−x}}]=Eᵢ[α_{p,m,i}·α*_{p,m,i-2}·e^{j(ϕ}^{ₜ}^{-ϕ}^{_{t−s}}^{)].}

As a result, the prediction accuracy cannot be guaranteed. However, note that the random phase does not distort the Eigen/subspace directions. For precoding purpose, channel construction with a phase offset across all antennas is acceptable. Therefore, the present disclosure provides to remove the impact of the ToFo by normalizing the phase utilizing antenna differentiation.

As illustrated in FIG. 8A, the noise and To/Fo 802 and the H(t) 804 are summed and generated into noisy H SRS 806. The noisy H SRS 806 and the previous subspace basis are entered together. At step 810, the base station update the subspace basis based on the noisy H SRS 806 and the previous subspace basis. At step 812, the base station computes subspace coefficients. At step 814, the base station collects the coefficient buffer based on the computed subspace coefficients at step 812. At step 816, the base station predicts [a1(t+1), a2(t+1) . . . ]. At step 818, the base station predicts H(t+1) with the updated subspace basis at step 810.

FIG. 8B illustrates an example antenna array 850 for a tracking and prediction operation according to embodiments of the present disclosure. An embodiment of the antenna array 850 shown in FIG. 8B is for illustration only.

As illustrated in FIG. 8B, an eNB include antenna arrays transmitting the beam to a UE that is moving in a cell.

In one embodiment, in every TTI, before the processing, the channel coefficient are normalized by the phase of the coefficient of a fixed reference. The normalization can be performed for either the phase only or both the phase and the amplitude. Denote the chosen reference as hᵣ, one method is to normalize the channel coefficients as: h^{proc}_{m,t,n}=h_{m,t,n}·e^{-jθ}, where θ=∠hᵣ.

Another method is to normalize the channel coefficients as:

$${h}_{m , t , n}^{proc} = {h}_{m , t , n} \cdot \frac{1}{a} {e}^{- j θ} ,$$

where αe^{jθ}=hᵣ.

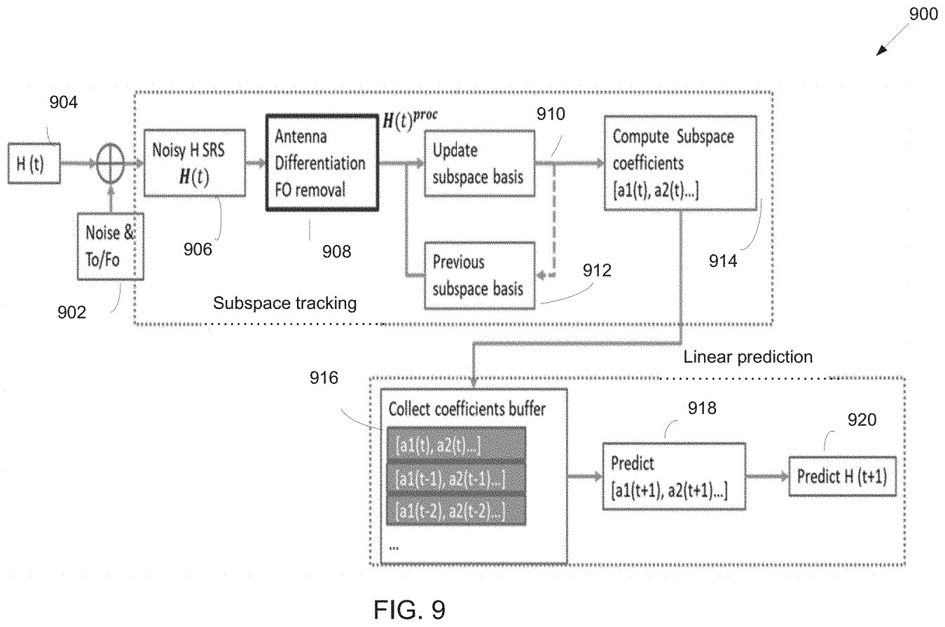

FIG. 9 illustrates an example ToFo impact removal operation 900 before entire processing according to embodiments of the present disclosure. For example, the ToFo impact removal operation 900 may be implemented by a base station such as 101-103 as illustrated in FIG. 1. An embodiment of the ToFo impact removal operation 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, the noise and To/Fo 902 and the H(t) 904 are summed and generated into the noisy H SRS H(t) 906. At step 908, the base station performs the antenna differentiation FO removal. The output of the antenna differentiation FO removal is used to update the subspace basis at step 910 and 912. At step 914, the base station computes subspaces coefficients [α1(t), a2(t) . . . ]. At step 916, the base station collects coefficients buffer. At step 918, the base station predicts [a1]t+1), a2(t+1) . . . ]. At step 920, the base station predicts H (t+1).

In another embodiment, the ToFo impact removal is performed after the subspace projection before the subspace coefficients tracking and prediction. The subspace direction coefficients can be normalized with respect to a certain reference. The normalization can be performed for either the phase only or both the phase and the amplitude. Denote the reference as hᵣ, one method is to normalize the coefficients as: [α₁, α₂, . . . α_{P}]^{proc}=[α₁, α₂, . . . α_{P}]e^{-jθ}, where θ=∠hᵣ.

In another embodiment, the channel coefficients is normalized as:

$${[ {α}_{1} , {α}_{2} , … , {α}_{P} ]}^{proc} = [ {α}_{1} , {α}_{2} , … , {α}_{P} ] \cdot \frac{1}{a} {e}^{- j θ} ,$$

where αe^{jθ}=hᵣ.

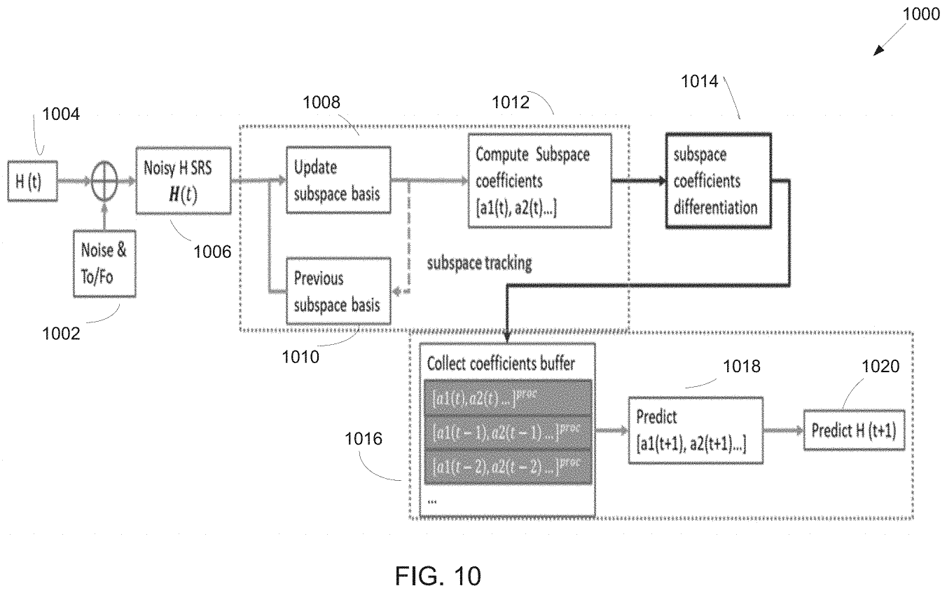

FIG. 10 illustrates an example ToFo impact removal operation 1000 after the subspace tracking operation according to embodiments of the present disclosure. For example, the ToFo impact removal operation 1000 may be implemented by a base station such as 101-103 as illustrated in FIG. 1. An embodiment of the ToFo impact removal operation 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, the noise and To/Fo 1002 and the H(t) 1004 are summed and generated into the noisy H SRS H(t) 1006. At step 1008, the base station updates the subspace basis with the previous subspace basis 1010. At step 1012, the base station computes subspaces coefficients [a1(t), a2(t) . . . ]. At step 1014, the base station performs the subspace coefficients differentiation. At step 1016, the base station collects coefficients buffer. At step 1018, the base station predicts [a1]t+1), a2(t+1) . . . ]. At step 1020, the base station predicts H (t+1).

When selecting the normalization reference hᵣ, a few options can be considered.

In one embodiment, the reference is selected as an antenna coefficient. The reference antenna can be chosen arbitrarily (but fixed over time) or chosen as the antenna that receives strongest power over an observation window.

In another embodiment, the reference antenna is chosen based on antenna location in the panel. For example, the antennas in the middle or the one that inherently experiences the least radio frequency circuit impairments.

In another embodiment, the reference is selected as the coefficient of a fixed Eigen/subspace direction. The Eigen direction can be chosen arbitrarily or chosen as the Eigen direction that has the strongest power over an observation window.

In another embodiment, a history of the signal received by the aforementioned reference may be used to further produce a better reference by means of filtering or denoising.

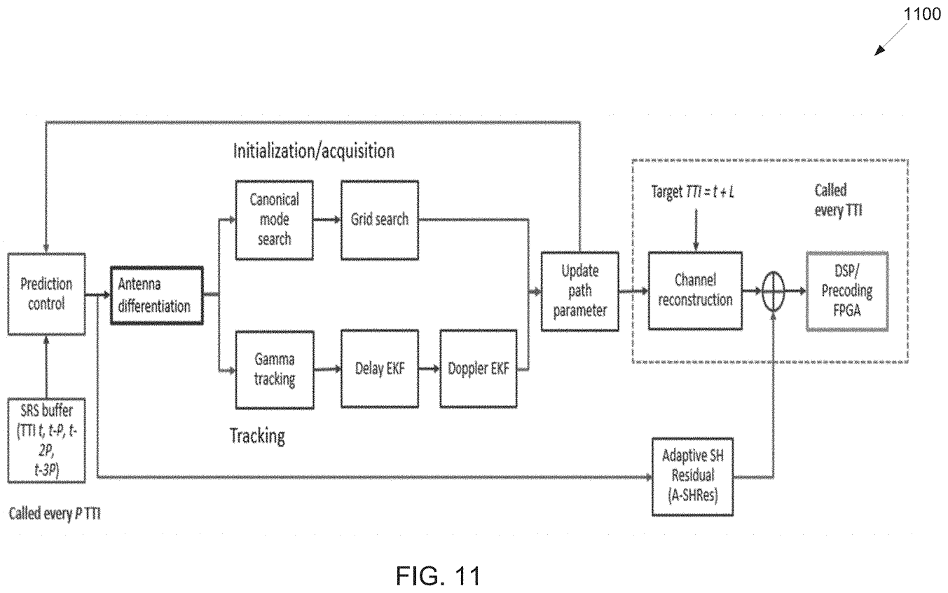

FIG. 11 illustrates an example antenna differentiation followed by channel tracking operation 1100 according to embodiments of the present disclosure. For example, the antenna differentiation followed by channel tracking operation 1100 may be implemented by a base station such as 101-103 as illustrated in FIG. 1. An embodiment of the antenna differentiation followed by channel tracking operation 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, a base station performs the prediction control at step 1104 based on the SRS buffer 1102 and the updated path parameters 1118. At step 1106, the base station performs the antenna differentiation. The output of the antenna differentiation is used for canonical mode search 1108 and the gamma tracking 1110. The output of the canonical mode search 1108 is used for the grid search 1113. The output of the gamma tracking 1110 is used for the delay EKF 1114 and the Doppler EKF 1116. The output of the grid search 1112 and the output of the Doppler EKF are used for updating the path parameters 1118. The base station performs the channel reconstruction based on the updated path parameter 1118. The output of the channel reconstruction 1120 and the output of the adaptive SH residual(A-SHRes) 1124 are used to be combined into DSP/precoding FPGA 1122.

Without the removal, the coefficients are very difficult to track, and the prediction is less inaccurate.

It may be observed that the channel coefficients on all the eNB antenna elements may not follow the same process. For instance, the eNB antennas are divided into two groups according to the polarization, the two groups display different power, and different estimated delay.

In one example, it is beneficial to divide the antennas into group(s) and perform the tracking/prediction on each group individually.

The aforementioned normalization can be performed to all group(s) jointly or for each group individually.

The reference can be chosen common for all group(s), or separately for each group.

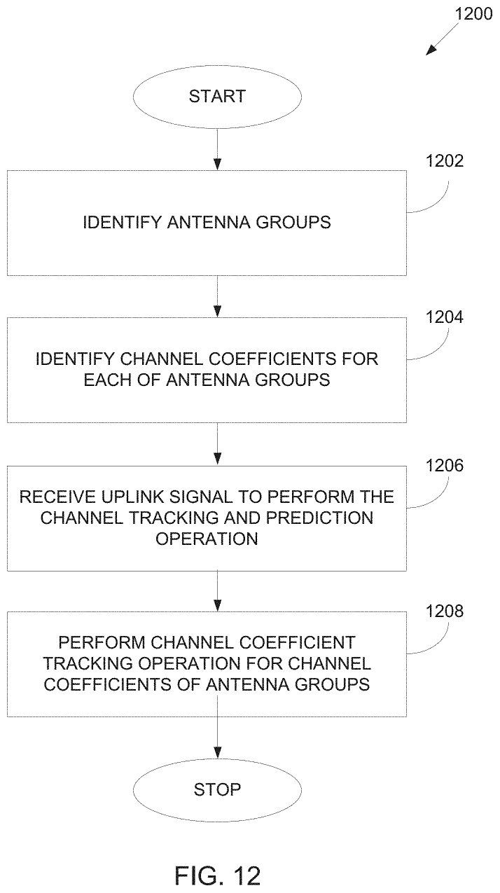

FIG. 12 illustrates a flowchart of a method 1200 for a multiple antenna channel tracking procedure according to embodiments of the present disclosure. For example, the method 1200 may be implemented by a base station such as 101-103 as illustrated in FIG. 1. An embodiment of the method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, the method 1200 begins at step 1202. In step 1202, a BS identifies antenna groups.

Subsequently, in step 1204, the BS identifies channel coefficients for each of the antenna groups to perform a channel tracking and prediction operation.

Next, in step 1206, the BS receives, from a user equipment (UE), an uplink signal to perform the channel tracking and prediction operation.

Finally, in step 1208, the BS performs, based at least in part on the received uplink signal, a channel coefficient tracking operation for the channel coefficients of the antenna groups, respectively, the channel coefficient tracking operation including a channel subspace parameter tracking operation and a subspace coefficient tracking operation.

In one embodiment, the BS identifies the antenna groups based on polarization directions of antennas, respectively, in the antenna groups, respectively or identifies the antenna groups based on geometry distances between the antennas, respectively, in antenna groups, respectively.

In one embodiment, the BS normalizes, based on a reference antenna, the channel coefficients for the antenna groups, respectively, based on at least one of a phase or an amplitude for an antenna differentiation operation and performs the channel tracking and prediction operation based on the normalized channel coefficients for the antenna groups, respectively.

In one embodiment, the BS normalizes the channel coefficients for the antenna groups, respectively, each of the antenna groups being jointly or individually normalized.

In one embodiment, the BS identifies subspace coefficients for the antenna groups, respectively, normalizes, based on a reference antenna or a subspace coefficient, the subspace coefficients for the antenna groups, respectively, based on at least one of a phase or an amplitude for a subspace coefficients differentiation operation, and performs the channel tracking and prediction operation based on the normalized subspace coefficients for the antenna groups, respectively.

In one embodiment, the BS normalizes the subspace coefficients for the antenna groups, respectively, each of the antenna groups being jointly or individually normalized.

In one embodiment, the BS randomly selects an antenna in the antenna groups and determining the selected antenna as a reference antenna for the channel subspace parameter tracking operation and a subspace coefficient tracking operation, or randomly selects a subspace coefficient and determining the selected subspace coefficient as a reference coefficient for the channel subspace parameter tracking operation and a subspace coefficient tracking operation.

In one embodiment, the BS identifies an observation window for measuring power of the antennas, selects, based on the observation window, an antenna with highest power among the antennas, and determines the selected antenna as a reference antenna for the channel subspace parameter tracking operation and a subspace coefficient tracking operation.

In one embodiment, the BS identifies an observation window for measuring power of the antennas, selects, based on the observation window, a subspace coefficient, and determines the selected subspace coefficient as a reference coefficient for the channel subspace parameter tracking operation and a subspace coefficient tracking operation.

For illustrative purposes the steps of this algorithm are described serially, however, some of these steps may be performed in parallel to each other. The above operation diagrams illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A base station (BS) comprising:
a processor configured to:
identify antenna groups, and
identify channel coefficients for each of the antenna groups to perform a channel tracking and prediction operation; and
a transceiver operably connected to the processor, the transceiver configured to receive, from a user equipment (UE), an uplink signal to perform the channel tracking and prediction operation,
wherein the processor is further configured to perform, based at least in part on the received uplink signal, a channel coefficient tracking operation for the channel coefficients of the antenna groups, respectively, the channel coefficient tracking operation including a channel subspace parameter tracking operation and a subspace coefficient tracking operation.

2. The BS of claim 1, wherein the processor is further configured to:
identify the antenna groups based on polarization directions of antennas, respectively, in the antenna groups, respectively; or
identify the antenna groups based on geometry distances between the antennas, respectively, in antenna groups, respectively.

3. The BS of claim 1, wherein the processor is further configured to:
normalize, based on a reference antenna, the channel coefficients for the antenna groups, respectively, based on at least one of a phase or an amplitude for an antenna differentiation operation; and
perform the channel tracking and prediction operation based on the normalized channel coefficients for the antenna groups, respectively.

4. The BS of claim 3, wherein the processor is further configured to normalize the channel coefficients for the antenna groups, respectively, each of the antenna groups being jointly or individually normalized.

5. The BS of claim 1, wherein the processor is further configured to:
identify subspace coefficients for the antenna groups, respectively;
normalize, based on a reference antenna or a subspace coefficient, the subspace coefficients for the antenna groups, respectively, based on at least one of a phase or an amplitude for a subspace coefficients differentiation operation; and
perform the channel tracking and prediction operation based on the normalized subspace coefficients for the antenna groups, respectively.

6. The BS of claim 5, wherein the processor is further configured to normalize the subspace coefficients for the antenna groups, respectively, each of the antenna groups being jointly or individually normalized.

7. The BS of claim 1, wherein the processor is further configured to:
randomly select an antenna in the antenna groups and determine the selected antenna as a reference antenna for the channel subspace parameter tracking operation and a subspace coefficient tracking operation; or
randomly select a subspace coefficient and determine the selected subspace coefficient as a reference coefficient for the channel subspace parameter tracking operation and a subspace coefficient tracking operation.

8. The BS of claim 1, wherein the processor is further configured to:
identify an observation window for measuring power of the antennas;
select, based on the observation window, an antenna with highest power among the antennas; and
determine the selected antenna as a reference antenna for the channel subspace parameter tracking operation and a subspace coefficient tracking operation.

9. The BS of claim 1, wherein the processor is further configured to:
identify an observation window for measuring power of the antennas;
select, based on the observation window, a subspace coefficient; and
determine the selected subspace coefficient as a reference coefficient for the channel subspace parameter tracking operation and a subspace coefficient tracking operation.

10. A method of a base station (BS), the method comprising:
identifying antenna groups;
identifying channel coefficients for each of the antenna groups to perform a channel tracking and prediction operation;
receiving, from a user equipment (UE), an uplink signal to perform the channel tracking and prediction operation; and
performing, based at least in part on the received uplink signal, a channel coefficient tracking operation for the channel coefficients of the antenna groups, respectively, the channel coefficient tracking operation including a channel subspace parameter tracking operation and a sub space coefficient tracking operation.

11. The method of claim 10, further comprising:
identifying the antenna groups based on polarization directions of antennas, respectively, in the antenna groups, respectively; or
identifying the antenna groups based on geometry distances between the antennas, respectively, in antenna groups, respectively.

12. The method of claim 10, further comprising:
normalizing, based on a reference antenna, the channel coefficients for the antenna groups, respectively, based on at least one of a phase or an amplitude for an antenna differentiation operation; and
performing the channel tracking and prediction operation based on the normalized channel coefficients for the antenna groups, respectively.

13. The method of claim 12, further comprising normalizing the channel coefficients for the antenna groups, respectively, each of the antenna groups being jointly or individually normalized.

14. The method of claim 10, further comprising:
identifying subspace coefficients for the antenna groups, respectively;
normalizing, based on a reference antenna or a subspace coefficient, the subspace coefficients for the antenna groups, respectively, based on at least one of a phase or an amplitude for a subspace coefficients differentiation operation; and
performing the channel tracking and prediction operation based on the normalized subspace coefficients for the antenna groups, respectively.

15. The method of claim 14, further comprising normalizing the subspace coefficients for the antenna groups, respectively, each of the antenna groups being jointly or individually normalized.

16. The method of claim 10, further comprising:
randomly selecting an antenna in the antenna groups and determining the selected antenna as a reference antenna for the channel subspace parameter tracking operation and a subspace coefficient tracking operation; or
randomly selecting a subspace coefficient and determining the selected subspace coefficient as a reference coefficient for the channel subspace parameter tracking operation and a subspace coefficient tracking operation.

17. The method of claim 10, further comprising:
identifying an observation window for measuring power of the antennas;
selecting, based on the observation window, an antenna with highest power among the antennas; and
determining the selected antenna as a reference antenna for the channel subspace parameter tracking operation and a subspace coefficient tracking operation.

18. The method of claim 10, further comprising:
identifying an observation window for measuring power of the antennas;
selecting, based on the observation window, a subspace coefficient; and
determining the selected subspace coefficient as a reference coefficient for the channel subspace parameter tracking operation and a subspace coefficient tracking operation.

19. A non-transitory computer-readable medium comprising program code, that when executed by a processor, causes a base station (BS) to:
identify antenna groups;
identify channel coefficients for each of the antenna groups to perform a channel tracking and prediction operation;
receive, from a user equipment (UE), an uplink signal to perform the channel tracking and prediction operation; and
perform, based at least in part on the received uplink signal, a channel coefficient tracking operation for the channel coefficients of the antenna groups, respectively, the channel coefficient tracking operation including a channel subspace parameter tracking operation and a subspace coefficient tracking operation.

20. The non-transitory computer-readable medium of claim 19, further comprising program code, that when executed by a processor, causes the BS to:
identify the antenna groups based on polarization directions of antennas, respectively, in the antenna groups, respectively; or
identify the antenna groups based on geometry distances between the antennas, respectively, in antenna groups, respectively.
